(19) United States
(12) Patent Application Publication
(10) Pub. No.: US 2026/0332767 A1
(43) Pub. Date: Oct. 22, 2026

(54) Method and Apparatus of Context Initialization for Entropy Coding in Video Coding Systems

(71) Applicant: MEDIATEK INC., Hsinchu City (TW)

(72) Inventors: Shih-Ta HSIANG, Hsinchu City (TW); Tzu-Der CHUANG, Hsinchu City (TW)

(21) Appl. No.: 19/105,916

(22) PCT Filed: Jul. 28, 2023
(86) PCT No.: PCT/CN2023/109710

§ 371 Date: Feb. 24, 2025

Related U.S. Application Data
(60) Provisional application No. 63/373,473, filed on Aug. 25, 2022.

(51) Int. Cl. H04N 19/13; H04N 19/124; H04N 19/174; H04N 19/70

(52) U.S. Cl. CPC H04N 19/13; H04N 19/124; H04N 19/174; H04N 19/70

(57) ABSTRACT

Methods and apparatus of context initialization for entropy coding. Previous context states derived from entropy coding previous slices are stored in context buffers together with previous coding parameters comprising QP associated with the previous slices. Target context states associated with a target QP are determined from the previous context states according to current coding parameters comprising a current QP associated with the current slice, where an absolute difference between the current QP and the target QP is smaller than a threshold and the threshold is non-negative. A current set of context states for the arithmetic entropy coder is initialized using the target context states. The input data are encoded or decoded using the arithmetic entropy coder after said initializing.

### CROSS REFERENCE TO RELATED APPLICATIONS

The present invention is a non-Provisional Application of and claims priority to U.S. Provisional Patent Application No. 63/373,473, filed on Aug. 25, 2022. The U.S. Provisional Patent Application is hereby incorporated by reference in its entirety.

### FIELD OF THE INVENTION

The present invention relates to video coding system. In particular, the present invention relates to context initialization for entropy coding in a video coding system to improve the coding performance.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video coding system incorporating loop processing. For Intra Prediction, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues.

The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an entropy decoder 140 to decode the video bitstream into quantized transform coefficients and needed coding information (e.g., ILPF information, Intra prediction information and Inter prediction information). The Intra prediction 150 at the decoder side does not need to perform the mode search. Instead, the decoder only need to generate Intra prediction according to Intra prediction information received from the Entropy Decoder 140. Furthermore, for Inter prediction, the decoder only needs to perform motion compensation (MC 152) according to Intra prediction information received from the Entropy Decoder 140 without the need for motion estimation.

A coded video sequence can be represented by a collection of coded layered video sequences. A coded layered video sequence can be further divided into more than one temporal sublayer. Each coded video data unit belongs to one particular layer identified by the layer index (ID) and one particular sublayer ID identified by the temporal ID. Both layer ID and sublayer ID are signalled in a network abstraction layer (NAL) header. A coded video sequence can be recovered at reduced quality or frame rate by skipping video data units belonging to one or more highest layers or sublayers. The video parameter set (VPS), the sequence parameter set (SPS) and the picture parameter set (PPS) contain high-level syntax elements that apply to a coded video sequence, a coded layered video sequence and a coded picture, respectively. The picture header (PH) and slice header (SH) contain high-level syntax elements that apply to a current coded picture and a current coded slice, respectively.

In VVC, a coded picture is partitioned into non-overlapped square block regions represented by the associated coding tree units (CTUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types (quad-tree partitioning 210, vertical binary tree partitioning 220, horizontal binary tree partitioning 230, vertical centre-side triple-tree partitioning 240, horizontal centre-side triple-tree partitioning 250) illustrated in FIG. 2. FIG. 3 provides an example of a CTU recursively partitioned by QT with the nested MTT. Each CU contains one or more prediction units (PUs). The prediction unit, together with the associated CU syntax, works as a basic unit for signalling the predictor information. The specified prediction process is employed to predict the values of the associated pixel samples inside the PU. Each CU may contain one or more transform units (TUs) for representing the prediction residual blocks. A transform unit (TU) comprises of a transform block (TB) of luma samples and two corresponding transform blocks of chroma samples and each TB correspond to one residual block of samples from one colour component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one colour component associated with CTU, CU, PU, and TU, respectively. Thus, a CTU consists of one luma CTB, two chroma CTBs, and associated syntax elements. A similar relationship is valid for CU, PU, and TU.

For achieving high compression efficiency, the context-based adaptive binary arithmetic coding (CABAC) mode, or known as regular mode, is employed for entropy coding the values of the syntax elements in HEVC and VVC. FIG. 4 illustrates an exemplary block diagram of the CABAC process. Since the arithmetic coder in the CABAC engine can only encode the binary symbol values, the CABAC process needs to convert the values of the syntax elements into a binary string using a binarizer (410). The conversion process is commonly referred to as binarization. During the coding process, the probability models are gradually built up from the coded symbols for the different contexts. The context modeller (420) serves the modelling purpose. During normal context based coding, the regular coding engine (430) is used, which corresponds to a binary arithmetic coder. The selection of the modelling context for coding the next binary symbol can be determined by the coded information. Symbols can also be encoded without the context modelling stage and assume an equal probability distribution, commonly referred to as the bypass mode, for reduced complexity. For the bypassed symbols, a bypass coding engine (440) may be used. As shown in FIG. 4, switches (S1, S2 and S3) are used to direct the data flow between the regular CABAC mode and the bypass mode. When the regular CABAC mode is selected, the switches are flipped to the upper contacts. When the bypass mode is selected, the switches are flipped to the lower contacts as shown in FIG. 4.

As the arithmetic coder in the CABAC engine can only encode the binary symbol values, the CABAC operation first needs to convert the value of a syntax element into a binary string, the process commonly referred to as binarization. During the coding process, the accurate probability models are gradually built up from the coded symbols for the different contexts. A set of storage units is allocated to trace the on-going context state, including accumulated probability state, for individual modelling contexts. The context states are initialized using the pre-defined modelling parameters for each context according to the specified slice QP. The selection of a particular modelling context for coding a binary symbol can be determined by a pre-defined rule or derived from the coded information. In VVC, initialization of context states is based on a linear model, assuming the relation between the probability state of a context variable and the slice QP is linear. A parameter pair (slope, offset) is predefined for each context variable for each slice type. The initial context state for each context variable is thus determined by the linear model according to the slice QP and the pre-defined parameter pair (slope, offset) for each context variable. Symbols can be coded without the context modelling stage and assume an equal probability distribution, commonly referred to as the bypass mode, for improving bitstream parsing throughput rate.

Joint Video Expert Team (JVET) of ITU-T SG16 WP3 and ISO/IEC JTC1/SC29 are currently in the process of exploring the next-generation video coding standard. Some promising new coding tools have been adopted into Enhanced Compression Model 5 (ECM 5) (M. Coban, et al., “Algorithm description of Enhanced Compression Model 5 (ECM 5),” Joint Video Expert Team (JVET) of ITU-T SG 16 WP 3 and ISO/IEC JTC 1/SC 29, 26th Meeting, by teleconference, 20-29 Apr. 2022, Document JVET-Z 2025) to further improve VVC. The adopted new tools have been implemented in the reference software ECM-5.0 (available online: https.//vegit.hhi.fraunhofer.de/ecm/ECM).

The present invention is intended to further improve the performance of the CABAC entropy coding in a video coding system.

### BRIEF SUMMARY OF THE INVENTION

A method and apparatus of context initialization for entropy coding are disclosed. According to this method, input data are received, wherein the input data comprise binary symbols for a set of syntax elements associated with a current slice in a current picture at an encoder side, or entropy coded bitstream of the binary symbols for the set of syntax elements associated with the current slice in the current picture at a decoder side, and wherein the current picture is inter coded. Previous context states for an arithmetic entropy coder are determined, wherein the previous context states derived from entropy coding one or more previous slices are stored in one or more context buffers together with one or more previous coding parameters comprising QP (Quantization Parameter) associated with said one or more previous slices. Target context states associated with a target QP are determined from the previous context states according to one or more current coding parameters comprising a current QP associated with the current slice, wherein an absolute difference between the current QP and the target QP is smaller than a threshold and the threshold is non-negative. A current set of context states for the arithmetic entropy coder is initialized using the target context states. The input data are encoded or decoded using the arithmetic entropy coder after said initializing the current set of context states for the arithmetic entropy coder.

According to one embodiment, said one or more previous coding parameters comprise previous slice types and previous TIDs (Temporal IDs) associated with said one or more previous slices and said one or more current coding parameters comprise a current slice type and a current TID associated with the current slice, and wherein the current slice type is equal to a target slice type associated with the target context states and the current TID is equal to a target TID associated with the target context states.

In one embodiment, the method further comprises storing the current set of context states resulted from said encoding or decoding the input data in said one or more context buffers if the current slice satisfies a pre-defined position in the current picture. For example, the pre-defined position corresponds to a last slice in the current picture. In another example, the pre-defined position corresponds to a centre slice in the current picture. In one embodiment, when said one or more context buffers are full and a set of context buffer contents associated with one or more corresponding coding parameters equal to said one or more current coding parameters does not exist, one set of context buffer contents having a QP value closest to the current QP or a TID value closest to the current TID is removed or replaced by current context states related to the current slice.

According to another method, input data are received, wherein the input data comprise binary symbols for a set of syntax elements associated with a current slice in a current picture at an encoder side, or entropy coded bitstream of the binary symbols for the set of syntax elements associated with the current slice in the current picture at a decoder side, and wherein the current picture is inter coded. Two or more sets of context states stored in a context buffer are determined for an arithmetic entropy coder, wherein each of two or more sets of context states is derived from entropy coding one or more previous slices. Target context states derived from said two or more sets of context states stored in the context buffer are determined. A current set of context states for the arithmetic entropy coder is initialized using the target context states. The input data are encoded or decoded using the arithmetic entropy coder after said initializing the of two or more sets of context states set of context states for the arithmetic entropy coder.

In one embodiment, the target context states are derived from said two or more sets of context states having a same slice type and sublayer ID as a current slice type and sublayer ID, and having previous QPs associated with said two or more sets context states closest to a current QP associated with the current slice. In another embodiment, the target context states are derived from said two or more context states having a same slice type and sublayer ID as a current slice type and sublayer ID, and having previous QPs with absolute differences between target QPs and a current QP associated with the current slice smaller than a non-negative threshold. In one embodiment, the non-negative threshold is signalled or parsed in an SPS (Sequence Parameter Set), a PPS (Picture Parameter Set), a PH (Picture Header), a SH (Slice Header) or a combination thereof. In one embodiment, the non-negative threshold is pre-defined.

In one embodiment, each of the target context states associated with a context index n is derived from corresponding context states of said two or more sets of previous context states associated with the context index n and the n is a non-negative integer. In one embodiment, said each of the target context states associated with the context index n is derived from a weighted sum of the corresponding context states of said two or more sets of previous context states associated with the context index n.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates that a CU can be split into smaller CUs using one of the five split types (quad-tree partitioning, vertical binary tree partitioning, horizontal binary tree partitioning, vertical centre-side triple-tree partitioning, and horizontal centre-side triple-tree partitioning).

FIG. 3 illustrates an example of a CTU being recursively partitioned by QT with the nested MTT.

FIG. 4 illustrates an exemplary block diagram of the CABAC process.

FIG. 5 illustrates a flowchart of an exemplary video coding system that comprises entropy coding with relaxed usage of stored modelling parameters according to an embodiment of the present invention.

FIG. 6 illustrates a flowchart of an exemplary video coding system that utilizes multiple stored sets of context states for initialization of entropy coding according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In ECM 5, the set of the context states after entropy coding the last CTU in a coded inter picture can be used to initialize the set of the context states for entropy coding a future inter slice having the same slice type, quantization parameter (QP), and temporal ID (TID) as the coded picture. A new set of the context states after entropy coding a current inter picture is stored in an assigned entry of a context state buffer in a video coder. When a stored set of context states that is generated by entropy coding a previous inter slice having the same slice type, QP, and TID as the current picture can be found in the context state buffer, the new set of the context states just replaces the stored set of context states corresponding to the same slice type, QP, and TID in the context state buffer. Otherwise, the new set of the context states is assigned to be stored in an empty entry in the context state buffer. When the context state buffer is already full, the stored context set associated with the entry having the smallest QP and temporal ID is removed first from the context state buffer before storing the new set of context states. In ECM-5.0 reference software implementation, an array of context state buffers ctxStateBuffers[NumInterSliceTypes] is created for storage of the sets of context states corresponding to different slice types, wherein NumInterSliceTypes indicates the number of different slice types and is equal to 2 (referring to B and P slice types in ECM 5). Each context state buffer stores the sets of context states that are resulted from entropy coding inter slices in previous pictures using one particular slice type. The allowed maximum buffer size is fixed to be equal to 5 (sets of context states) for each of the two context state buffers. The context state for each context in a stored set may include entries for tracing long-term probability, short-term probability, and weighting factors for deriving the predicted probability.

Before starting entropy coding a current inter slice, the ECM 5 video coder will first search the context state buffer for a stored set of context states having the same slice type, QP, and TID as the current slice. The slice type, QP, and TID are referred as coding parameters in this disclosure. Accordingly, a set of context states is stored for each coding parameter combination (i.e., slice type, QP, and TID). If such a stored set can be found, the video coder will copy each context state in the stored set to the corresponding context state in the current slice. Otherwise, the set of the context states in the current slice are not initialized by any stored set of context states in the context state buffer. The context states in the current slice are just initialized by the pre-defined default method in VVC. In other words, in ECM 5, initialization of context states for a current slice is achieved by simply copying the corresponding context states from the selected stored context set. Therefore, no modeling parameters are involoved for initialization and storage of context state information. However, “modelling parameters” may just refer to “context states” of context variables or may broadly refer to various methods for context initialization from the stored context states according to modelling parameters, including 1-to-1 mapping for copying.

In ECM 5, the maximum context state buffer size is set to be equal to 5 for each slice type. When rate control is enabled for video coding, the adopted slice QP may be dynamically changed from slice to slice to meet the allocated bit budget for a current slice. Given a limited context state buffer size, a video coder may often fail to find a stored set of context states having the same slice type, QP, and TID as the current slice in the context state buffer. In the present invention, several new methods are disclosed for improving initialization of context states for entropy coding video sequences.

In one embodiment of the present invention, the requirement of using a set of context states have the same coding parameter combination (i.e., slice type, QP, and TID) is relaxed. In other words, at least one of the coding parameter combination being different is allowed according to an embodiment of the present invention. For example, the current QP does not have to be the same as the QP of a stored set of context states. For example, when the two slices from two temporally adjacent pictures corresponding to the same sliced type and TID are coded with close slice QP values, it is expected that the context states of the two slices shall correspond to similar statistical characteristics. According to one aspect of the present invention, a video coder may be allowed to further utilize the stored set corresponding to the QP value unequal but close to the current slice QP for initialization of context states for entropy coding a current slice. In this way, a video coder may improve the chance of initializing context states for entropy coding a current picture using a stored set of context states generated from a coded previous picture. In the proposed method, a video coder may further comprise a specified threshold T0, where T0 is a non-negative integer. When the absolute difference between a current slice quantization parameter QP_{c} and a previous quantization parameter QPₖ corresponding to a stored context set k is less than or equal to T0 and the current slice and the stored set k correspond to the same slice type and TID, the stored context set k may be allowed to be utilized for initialization of context states for entropy coding the current slice.

In one embodiment, after entropy coding a last slice in the current picture, the current context states can be stored in the context buffer for initializing the entropy coder for a next picture. While the context states for the last slice in a current picture are stored, the context states associated another slice location within a picture can be stored. For example, the context states for a centre slice in the current picture can be stored instead of the last slice.

When more than one stored context set is allowed, the video coder may choose the stored context set from the more than one stored context set by some pre-defined methods. In one example, the video coder may first choose the stored context set having the closest QP value to QP_{c}. In another example, the video coder may first choose the latest context set according to the storage order into the context state buffer or the video decoding order among the more than one stored set. In yet another example, the video coder may first choose the stored set that is generated from the coded previous picture having the shortest temporal distance from the current picture, wherein the temporal distance between the current picture and the previous picture may be derived from the associated picture order count (POC) values. In some embodiment, a video coder may jointly consider the slice QP, storage or decoding order and temporal distance corresponding to each of the more than one stored set to determine the selected set for initialization of context states in the current picture. In some embodiments, the video coder will always first choose the stored set having the same sliced type, QP and TID as the current slice before considering other stored sets corresponding the QP values unequal to the current slice QP.

In some embodiments, the specified threshold T0 can be a predefined positive integer. In some other embodiments, the specified threshold T0 can be a non-negative integer signalled in the bitstream. For example, T0 can be coded in one or more high-level syntax sets such as SPS, PPS, PH, and/or SH. When T0 is set equal to 0, only the stored set having the same QP as the current slice QP can be used for context initialization. In some embodiments, different T0 values can be specified for initialization of the context states for entropy coding inter slices corresponding to different slice types and TIDs.

In ECM 5, the context states for entropy coding a current inter slice can be initialized by copying one stored set of the context states from the context state buffer to the corresponding context states in the current slice. According to another aspect of the present invention, a video coder may jointly utilize more than one stored set of context states for initialization of the context states for entropy coding a current slice. In one proposed method, a video coder may set the initial state of a context equal to the weighted sum of the corresponding states in the two stored sets for each context in the current slice. For example, a video coder may set the initial probability state for a context with an index n for all n's in a stored context set as follows:

P_{c}(n)=w₀·P₀(n)+w₁·P₁(n),

where P₀(n) and P1(n) are the probability states of context n in the two selected sets indexed by 0 and 1, respectively, and w₀ and w₁ are weighting factors. The weighting factors can be either signalled in the bitstream or derived by some pre-determined methods. In some embodiments, the weighting factors can be derived considering the QP values associated with the current slice and the selected sets from the context state buffer. In some specific embodiments, the weighting factors can be derived according to the absolute difference between the current slice QP and the QP value associated with each of the selected sets. For example, a video coder may set the initial probability state for a context with an index n as follows:

P_{c}(n)=(ΔQP₁·P₀(n)+ΔQP₀·P₁(n))/(ΔQP₁+ΔQP₀),

ΔQP₀=|QP₀−QP_{c}|,

ΔQP₁=|QP₁−QP_{c}|,

where QP_{c}, QP₀, and QP₁ are the QP values associated with the current slice and the two selected sets of context buffers, respectively, and |⋅|returns the absolute value of the input. In one simplified embodiment, the initial probability state for context n in a current slice can be set as follows:

P_{c}(n)=(P₀(n)+P₁(n))>>1,

where the operator “>>” represents a bit-wise down-shift operation.

In some embodiments, a video coder can choose more than one stored set of context states from the context buffer considering the slice type, TID and QP associated with the current slice and each entry in the context state buffer. For example, the video coder may choose the two entries having the same slice type and TID as the current slice and the nearest QP values to the current slice QP. The video coder may further comprise a specified threshold T2, where T2 is a non-negative integer. When the absolute difference between a current slice quantization parameter QP_{c} and a previous quantization parameter QPₖ corresponding to a stored context set k is less than or equal to T2, the stored context set k may be allowed to be utilized for initialization of context states for entropy coding the current slice. The video coder can consider QP, storage or decoding order and temporal distances corresponding to the allowed sets in the context state buffer to determine the selected more than one stored set for initialization of context states in the current picture. In some embodiments, a video coder can apply more than one stored set of context states for initialization of context states in a current slice only when the current context state buffer does not contain any stored entry having the same slice type, QP, and TID values as those of the current slice. The value of threshold T2 can be either pre-defined or explicitly signalled in the bitstream, such as in the SPS, PPS, PH, and/or SH.

According to another aspect of the present invention, a video coder may jointly utilize one or more stored sets of context states and the context states derived by the pre-defined method for initialization of the context states for entropy coding a current slice. In one embodiment, a video coder may set the initial probability state for a particular context in a current slice as follows:

P_{c}(QPc)=ws·Ps(QPs)+wp·Pp(QPc)+wd·(Pp(QPc)−Pp(QPs) ),

where QP_{c} is the slice QP for the current slice, Pₛ (QPs) is the stored probability state of the particular context in the selected set that is generated by a coded previous picture having a QP value equal to QPₛ, Pₚ(QP_{c}) and Pₚ(QPₛ) are probability states derived by the pre-defined method given the input QP values equal to QP_{c} and QPₛ, respectively, and wₛ, wₚ and w_{d} are weighting factors. The weighting factors can be derived considering the QP values associated with the current slice and the selected one or more sets from the context state buffer. In some further embodiments, the weighting factors can be derived considering the absolute difference between the current slice QP and the QP value associated with each of selected one or more sets. In one setting, wₛ, is set equal to 1, wₚ is set equal to 0 and wₐ is set to be less than or equal to 1. In another setting, wₚ and wₛ are set to be less than or equal to 1 and wₐ is set equal to 0.

In ECM-5.0, when a stored set of context states having the same slice type, QP, and TID as a coded current picture can be found in the context state buffer, the new set of the context states from the coded current picture just replaces the stored set of context states in the context state buffer. Otherwise, when the context state buffer is full, the stored set of context states associated with the entry having the smallest QP and temporal ID is removed first from the context state buffer before storing the new set of context states from the coded current picture. In another embodiment, when the context buffer is full and a set of context buffer contents associated with the corresponding coding parameters equal to the current coding parameters does not exist, one set of context buffer contents having a QP value closest to the current QP or a TID value closest to the current TID can be removed or replaced by current context states related to the current slice. According to another aspect of the present invention, when a stored set of context states having the same slice type, QP, and TID as a coded current picture cannot be found, a video coder may choose to remove or replace a stored context set having a QP value unequal but close to the slice QP of the coded current picture for storing the new set of context states of the coded current picture in the context state buffer, wherein the stored context set chosen to removed or replaced may not be the default context set (having the smallest QP and temporal ID) to be removed when the context state buffer is full. In this way, the context state buffer may be able to store context sets corresponding to diverse QP & TID values.

In the proposed method, a video coder may further comprise a specified threshold T1, where T1 is a non-negative integer. When the absolute difference between a current slice quantization parameter QP_{c} and a previous quantization parameter QPₖ corresponding to a stored context set k is less than or equal to T1 and the current slice and the stored set k correspond to the same slice type and TID, the video coder may first choose to remove or replace the stored context set k for storing the new set of context states in the context state buffer. When more than one stored context set can be found for removal or replacement in the context buffer, the video coder may choose the stored context set from the more than one stored context set by some pre-defined methods. In one example, the video coder may first choose the stored context set having the closest QP value to QP_{c}. In another example, the video coder may first choose the latest or earliest context set according to the storage order into the context state buffer or the decoding order among the more than one stored context set. In yet another example, the video coder may first choose the stored set that is generated from the previous picture having the shortest or longest temporal distance from the current picture, wherein the temporal distance between the current picture and the previous picture may be derived from the associated picture order count (POC) values. In some embodiment, a video coder may jointly consider the slice QP, storage or decoding order and temporal distances corresponding to each of the more than stored set to determine the selected set for removal or displacement in the current picture.

In some embodiments, the specified threshold T1 can be a predefined positive integer. In some other embodiments, the specified threshold T1 can be a non-negative integer signalled in the bitstream. For example, T1 can be coded in one or more high-level syntax sets such as SPS, PPS, PH, and/or SH. In some embodiments, different T1 values can be specified for storing the context states generated by entropy coding inter slices corresponding to different slice types and TIDs. In some embodiments, T1 can be dependent on whether the context state buffer is full or not. In one of preferred embodiment, when the context state buffer is not full, T1 is set equal to 0. Otherwise, T1 is set equal to a positive integer. In some embodiments, when the context state buffer is full, T1 can be derived considering the slice type, QP, and TIP values of the stored sets of context states. For example, a video coder can derive T1 dependent on the slice type, QP, and TIP values of one or more candidate sets of context states for removal from the context state buffer, wherein the one or more candidate sets can be the stored sets of the context states subject to removal from the context state buffer when T1 is equal to 0 or derived by other pre-defined methods.

In ECM-5.0, when a stored set of context states having the same slice type, QP, and TID as a coded current picture can be found in the context state buffer, the new set of the context states from the coded current picture just replaces the stored set of context states in the context state buffer. According to another aspect of the present invention, a video coder may store more than one sets of context states corresponding to the same slice type, QP, and TID values in a context state buffer. When more than one sets of context states having the same slice type, QP, and TID as those of a current slice in a context state buffer, a video coder may initialize the set of context states in the current slice using the more than one sets of context states jointly or using one of the more than one sets selected by some pre-defined methods.

According to another aspect of the present invention, a video coder may choose to remove or replace a stored context set for storing a new set of context states from a coded current picture according to the storage order into context state buffer or the decoding order. In one embodiment, when the context state buffer is already full, a video coder may choose the earliest set of context states corresponding to the same TID as that of the current picture to be removed or replaced in the context state buffer.

The proposed methods can be jointly supported in a video coder. The video coder may further comprise signalling one or more high-level syntax elements in the high-level syntax set such as the SPS, PPS, PH, and SH to indicate which method is selected for context initialization in a current video sequence.

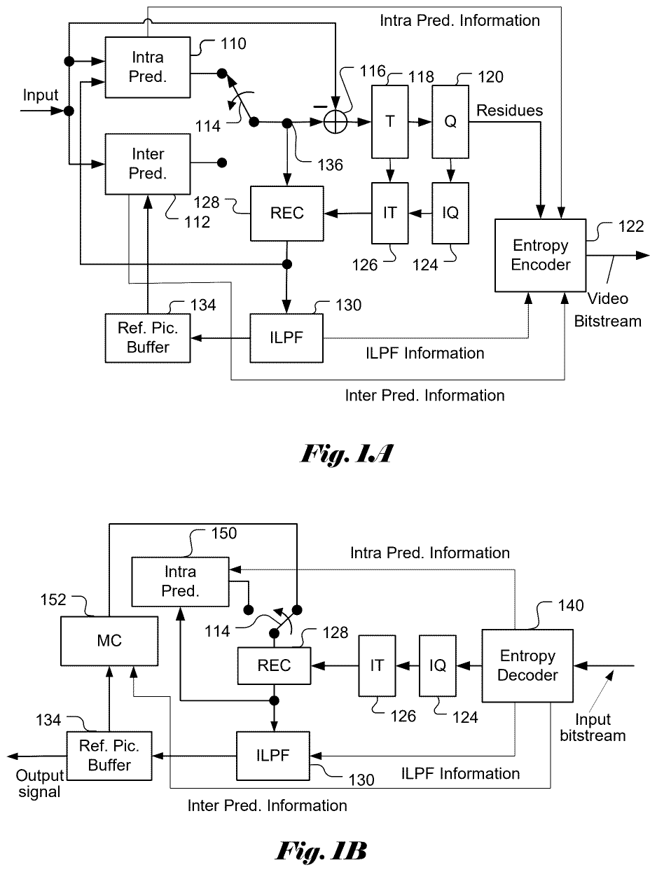

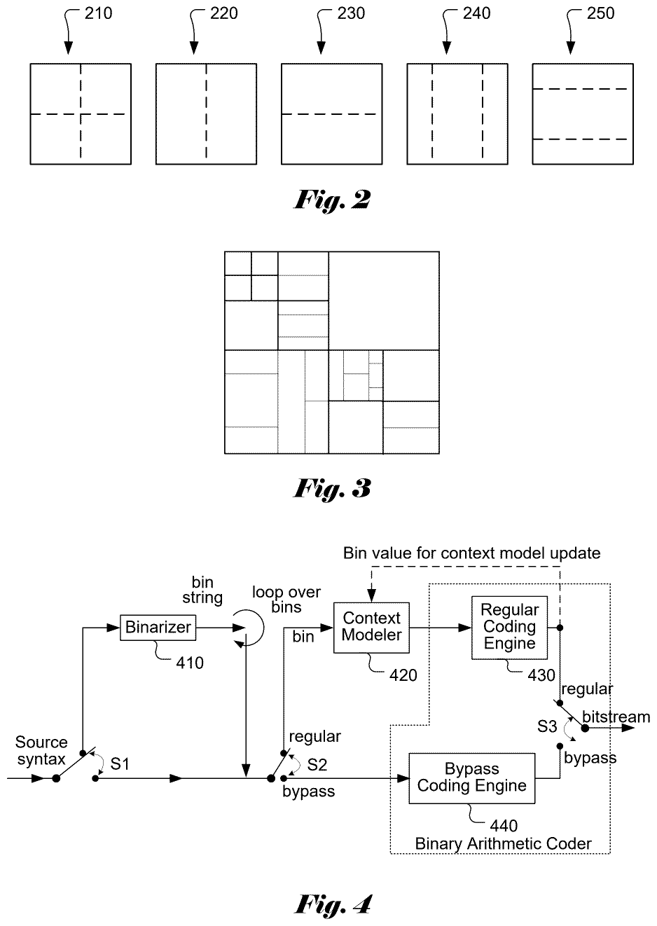

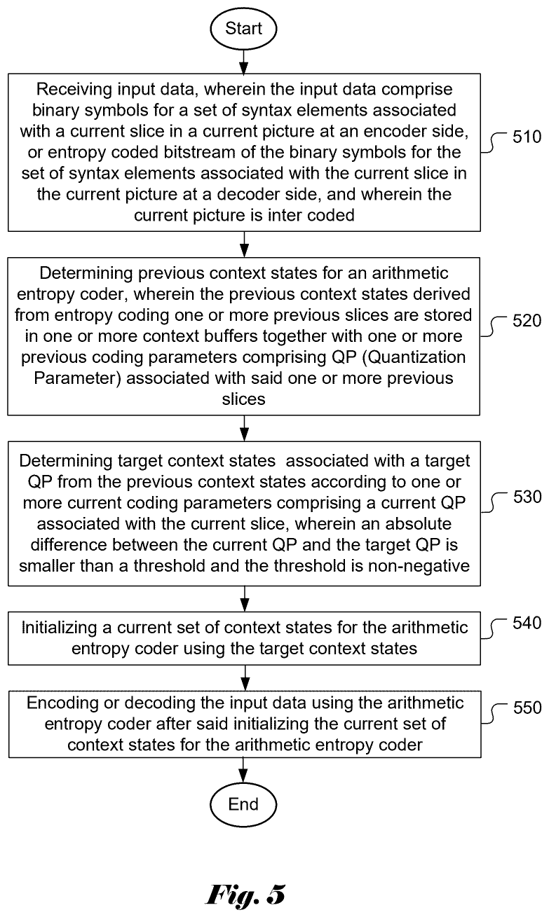

Any of the foregoing proposed entropy coding methods with relaxed usage of stored modelling parameters or using multiple sets of context states can be implemented in encoders and/or decoders. For example, any of the proposed methods can be implemented in the entropy coding module (e.g., Entropy Encoder 122 in FIG. 1A) of an encoder, and/or the entropy coding module (e.g., Entropy Decoder 140 in FIG. 1B) of a decoder. Alternatively, any of the proposed methods can be implemented as a circuit integrated to the entropy coding module of an encoder, and/or the entropy coding module of a decoder. The proposed aspects, methods and related embodiments can be implemented individually and jointly in a video coding system.

FIG. 5 illustrates a flowchart of an exemplary video coding system that comprises entropy coding with relaxed usage of stored modelling parameters according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data are received in step 510, wherein the input data comprise binary symbols for a set of syntax elements associated with a current slice in a current picture at an encoder side, or entropy coded bitstream of the binary symbols for the set of syntax elements associated with the current slice in the current picture at a decoder side, and wherein the current picture is inter coded. Previous context states for an arithmetic entropy coder are determined in step 520, wherein the context states derived from entropy coding one or more previous slices are stored in one or more context buffers together with one or more previous coding parameters comprising QP (Quantization Parameter) associated with said one or more previous slices. Target context states associated with a target QP are determined from the previous context states according to one or more current coding parameters comprising a current QP associated with the current slice in step 530, wherein an absolute difference between the current QP and the target QP is smaller than a threshold and the threshold is non-negative. A current set of context states for the arithmetic entropy coder is initialized using the target context states in step 540. The input data are encoded or decoded using the arithmetic entropy coder after said initializing the current set of context states for the arithmetic entropy coder in step 550.

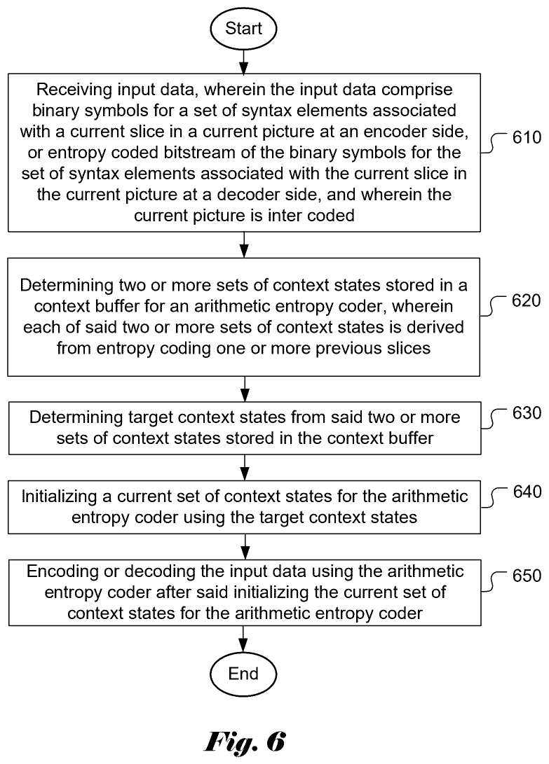

FIG. 6 illustrates a flowchart of an exemplary video coding system that utilizes multiple stored sets of context states for initialization of entropy coding according to an embodiment of the present invention. According to another method, input data are received in step 610, wherein the input data comprise binary symbols for a set of syntax elements associated with a current slice in a current picture at an encoder side, or entropy coded bitstream of the binary symbols for the set of syntax elements associated with the current slice in the current picture at a decoder side, and wherein the current picture is inter coded. Two or more sets of context states stored in a context buffer are determined for an arithmetic entropy coder in step 620, wherein each set of previous modelling parameters is derived from entropy coding one or more previous slices. Target context states derived from said two or more sets of context states stored in the context buffer are determined in step 630. A set of context states for the arithmetic entropy coder is initialized using the target context states in step 640. The input data are encoded or decoded using the arithmetic entropy coder after said initializing the set of context states for the arithmetic entropy coder in step 650.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data, wherein the input data comprise binary symbols for a set of syntax elements associated with a current slice in a current picture at an encoder side, or entropy coded bitstream of the binary symbols for the set of syntax elements associated with the current slice in the current picture at a decoder side, and wherein the current slice is inter coded;
determining previous context states for an arithmetic entropy coder, wherein the previous context states derived from entropy coding one or more previous slices are stored in one or more context buffers together with one or more previous coding parameters comprising QP (Quantization Parameter) associated with said one or more previous slices;
determining target context states associated with a target QP from the previous context states according to one or more current coding parameters comprising a current QP associated with the current slice, wherein an absolute difference between the current QP and the target QP is smaller than a threshold and the threshold is non-negative;
initializing a current set of context states for the arithmetic entropy coder using the target context states; and
encoding or decoding the input data using the arithmetic entropy coder after said initializing the current set of context states for the arithmetic entropy coder.

2. The method of claim 1, wherein said one or more previous coding parameters comprise previous slice types and previous TIDs (Temporal IDs) associated with said one or more previous slices and said one or more current coding parameters comprise a current slice type and a current TID associated with the current slice, and wherein the current slice type is equal to a target slice type associated with the target context states and the current TID is equal to a target TID associated with the target context states.

3. The method of claim 1, further comprising storing the current set of context states resulted from said encoding or decoding the input data in said one or more context buffers if the current slice satisfies a pre-defined position in the current picture.

4. The method of claim 3, wherein the pre-defined position corresponds to a last slice in the current picture.

5. The method of claim 3, wherein the pre-defined position corresponds to a centre slice in the current picture.

6. The method of claim 3, wherein when said one or more context buffers are full and a set of context buffer contents associated with one or more corresponding coding parameters equal to said one or more current coding parameters does not exist, one set of context buffer contents having a QP value closest to the current QP or a TID value closest to the current TID is removed or replaced by current context states related to the current slice.

7. An apparatus of video decoding, the apparatus comprising one or more electronic circuits or processors arranged to:
receive input data, wherein the input data comprise binary symbols for a set of syntax elements associated with a current slice in a current picture at an encoder side, or entropy coded bitstream of the binary symbols for the set of syntax elements associated with the current slice in the current picture at a decoder side, and wherein the current slice is inter coded;
determine previous context states for an arithmetic entropy coder, wherein the previous context states derived from entropy coding one or more previous slices are stored in one or more context buffers together with one or more previous coding parameters comprising QP (Quantization Parameter) associated with said one or more previous slices;
determine target context states associated with a target QP from the previous context states according to one or more current coding parameters comprising a current QP associated with the current slice, wherein an absolute difference between the current QP and the target QP is smaller than a threshold and the threshold is non-negative;
initialize a current set of context states for the arithmetic entropy coder using the target context states; and
encode or decode the input data using the arithmetic entropy coder after the current set of context states for the arithmetic entropy coder is initialized.

8. A method of video coding, the method comprising:
receiving input data, wherein the input data comprise binary symbols for a set of syntax elements associated with a current slice in a current picture at an encoder side, or entropy coded bitstream of the binary symbols for the set of syntax elements associated with the current slice in the current picture at a decoder side, and wherein the current slice is inter coded;
determining two or more sets of context states stored in a context buffer for an arithmetic entropy coder, wherein each of said two or more sets of context states is derived from entropy coding one or more previous slices;
determining target context states derived from said two or more sets of context states stored in the context buffer;
initializing a current set of context states for the arithmetic entropy coder using the target context states; and
encoding or decoding the input data using the arithmetic entropy coder after said initializing the current set of context states for the arithmetic entropy coder.

9. The method of claim 8, wherein the target context states are derived from said two or more sets of context states having a same slice type and sublayer ID as a current slice type and sublayer ID, and having previous QPs associated with said two or more sets context states closest to a current QP associated with the current slice.

10. The method of claim 9, wherein the target context states are derived from said two or more sets of context states having a same slice type and sublayer ID as a current slice type and sublayer ID, and having previous QPs with absolute differences between previous QPs and a current QP associated with the current slice smaller than a non-negative threshold.

11. The method of claim 10, wherein the non-negative threshold is signalled or parsed in an SPS (Sequence Parameter Set), a PPS (Picture Parameter Set), a PH (Picture Header), a SH (Slice Header) or a combination thereof.

12. The method of claim 10, wherein the non-negative threshold is pre-defined.

13. The method of claim 8, wherein each of the target context states associated with a context index n is derived from corresponding context states of said two or more sets of previous context states associated with the context index n and the n is a non-negative integer.

14. The method of claim 13, wherein said each of the target context states associated with the context index n is derived from a weighted sum of corresponding context states of said two or more sets of previous context states associated with the context index n.

15. The method of claim 8, further comprising storing the current set of context states resulted from said encoding or decoding the input data in said one or more context buffers if the current slice satisfies a pre-defined position in the current picture.

16. The method of claim 15, wherein the pre-defined position corresponds to a last slice in the current picture.

17. The method of claim 15, wherein the pre-defined position corresponds to a centre slice in the current picture.

18. An apparatus of video decoding, the apparatus comprising one or more electronic circuits or processors arranged to:
receive input data, wherein the input data comprise binary symbols for a set of syntax elements associated with a current slice in a current picture at an encoder side, or entropy coded bitstream of the binary symbols for the set of syntax elements associated with the current slice in the current picture at a decoder side, and wherein the current slice is inter coded;
determine two or more sets of context states stored in a context buffer for an arithmetic entropy coder, wherein each of said two or more sets of context states is derived from entropy coding one or more previous slices;
determine target context states derived from said two or more sets of context states stored in the context buffer;
initialize a current set of context states for the arithmetic entropy coder using the target context states; and
encode or decode the input data using the arithmetic entropy coder after the current set of context states for the arithmetic entropy coder is initialized.
